(19) United States
(12) Patent Application Publication
(10) Pub. No.: US 2006/0268878 A1
(43) Pub. Date: Nov. 30, 2006

(54) Apparatus and method for transmitting and receiving a multi-user packet in a mobile communication system

(75) Inventors: Jung-Soo Jung, Seongnam-si (KR); Beom-Sik Bae, Suwon-si (KR); Dae-Gyun Kim, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/417,205

(22) Filed: May 4, 2006

(30) Foreign Application Priority Data
May 4, 2005 (KR) 2005-37775

(51) Int. Cl. H04L 12/56

(52) U.S. Cl. 370/392; 370/349

(57) ABSTRACT

An apparatus and method for transmitting and receiving a multi-user packet in a mobile communication system are provided. The mobile communication system includes an Access Network Transceiver System (ANTS) for communicating with Access Terminals (ATs) and the ATs for performing packet data communication within an area of the ANTS. The ANTS generates and transmits one packet with data to be transmitted to the ATs. The ATs receive the packet. The apparatus and method can support more than a specific number of ATs with the support of an existing system by correcting a header of the multi-user packet, and can support a number of users increased on a carrier-by-carrier basis without changing a physical transmission structure of an existing Evolution Data Only (EVDO) system.

### CROSS-REFERENCE TO RELATED APPLICATIONS

This application claims priority under 35 U.S.C. §119 to application Serial No. 2005-37775 filed in the Korean Intellectual Property Office on May 4, 2005, the entire disclosure of which is hereby incorporated by reference.

### BACKGROUND OF THE INVENTION

1. Field of the Invention

The present invention generally relates to an apparatus and method for transmitting and receiving a data packet in a mobile communication system. More particularly, the present invention relates to an apparatus and method for transmitting and receiving a multi-user packet in a mobile communication system.

2. Description of the Related Art

Recently, a large amount of research is being conducted on high rate data transmission in a Code Division Multiple Access (CDMA) mobile communication system. A typical mobile communication system with a channel structure for high rate data transmission is a 1× Evolution Data Only (1× EVDO) system. The 1× EVDO system is a mobile communication system proposed by the Third-Generation Partnership Project 2 (3GPP2) for data communication enhancement of an IS-2000 system.

In a forward channel structure of the 1× EVDO system, a pilot channel, a forward Medium Access Control (MAC) channel, a forward traffic channel, a forward control channel, and so on are transmitted based on Time Division Multiplexing (TDM). A group of transmitted signals based on the TDM is referred to as a burst.

A user data packet is transmitted in the forward traffic channel. A control message is transmitted in the forward control channel. The forward MAC channel is used to transmit reverse rate control information and power control information or designate a forward data transmission channel.

Reverse channels of the 1× EVDO system have different Identifiers (IDs) on a terminal-by-terminal basis, which are different from the forward channels. The reverse channels of each Access Terminal (AT) include a pilot channel, a reverse traffic channel, an access channel, a Data Rate Control (DRC) channel, a Reverse Rate Indicator (RRI) channel, and so on. A user data packet is also transmitted in the reverse traffic channel. The DRC channel is used to indicate a forward transmission rate for the AT. The RRI channel is used to indicate a transmission rate of a transmitted reverse data channel. The access channel is used when the AT transmits a message or traffic to an Access Network Transceiver System (ANTS) before the traffic channel is connected.

FIG. 1 illustrates a network structure of the conventional EVDO system. A rate control operation and channels associated therewith in the 1× EVDO system will be described with reference to FIG. 1.

Referring to FIG. 1, reference numeral 110 denotes ATs, reference numeral 120 denotes ANTSs, and reference numeral 130 denotes Access Network Controllers (ANCs). The 1× EVDO system coupled to an Internet network 150 is provided with a Packet Data Service Node (PDSN) 140 for transmitting high rate packet data to the ANTSs 120 and the ANCs 130 for controlling the ANTSs 120.

The ANTSs 120 communicate with the ATs 110 by wireless transmission, and transmit the high rate packet data to an AT 110a with the highest transmission rate. When a transmission rate of a forward channel is controlled, the ATs 110 measure reception strengths of pilots transmitted from the ANTSs 120, and set desired forward data rates on the basis of the measured reception strengths of the pilots. The ATs 110 transmit DRC information mapped to the set forward data rates to the ANTSs 120 through DRC channels. Upon receiving the DRC information, the ANTSs 120 can transmit packet data to only the AT 110a in a good state at a transmission rate reported thereby. A mapping relation between the forward channel state and the DRC information can differ according to implementation, but is conventionally set to use values fixed in an AT manufacturing process.

FIG. 2 is a table illustrating a relation among a DRC value reported by an AT, a transmission rate, and a transmission format mapped thereto in the EVDO system.

Referring to FIG. 2, a transmission format is expressed in a format such as (1024, 16, 1024). The transmission format (1024, 16, 1024) indicates that 1024-bit information is transmitted in 16 slots and a 1024-chip preamble is transmitted at the beginning of the transmission. An ANTS transmits data to each AT in a transmission format mapped to a DRC value reported thereby. The AT attempts to receive a forward data channel in only a format mapped to a DRC value reported thereby, because there is not another channel for indicating a transmission rate of the forward data channel to be transmitted. That is, when the ANTS transmits data in a transmission format different from that reported by the AT, the AT cannot receive the data because a method for indicating the different transmission format is absent. Thus, the ANTS always transmits data in only the transmission format mapped to (or compatible with) a DRC value reported by the AT. For example, when the AT transmits a DRC value of 0×1 through a DRC channel, the ANTS transmits, to the AT, data using the transmission format (1024, 16, 1024) mapped to the DRC value, and the AT attempts to receive the data in only that transmission format.

When transmitting data to the AT, the ANTS indicates a user to receive forward data using a preamble of a length defined in a transmission format. This preamble is computed by spreading a preset bit sequence with a Walsh code mapped to a MAC Identifier (ID) allocated from the ANTS to the AT. The AT determines whether to receive data by receiving a signal of chips corresponding to the preamble length defined in the transmission format reported thereby, despreading the received chips with a Walsh code mapped to it own MAC ID, and comparing the signal strength and value of the received chips with those of the preset bit sequence.

Packet data transmitted from the ANTS to one AT according to the received DRC information is referred to as a single user packet. In a general data service, the ANTS transmits data using the single user packet. Data services such as Voice over Internet Protocol (IP) are different from the general data service and require a relatively low transmission bandwidth of approximately 9.6 kbps. In the bandwidth of 9.6 kbps, only data of approximately 192 bits is transmitted in every 20 ms. When this small amount of data is transmitted in a single user packet with a size of at least 1024 bits, an unnecessary bandwidth waste occurs. To prevent a resource waste in a wireless access interval, a method for transmitting data of many users in one physical packet has been introduced. This packet is referred to as a Multi-User Packet (MUP).

FIG. 3 illustrates a definition of a multi-user packet compatible with a DRC value reported by an AT in the EVDO system.

Referring to FIG. 3, each DRC index is mapped to a data rate and a format of a packet to be transmitted to multiple users. Next, an example of the sixth index illustrated in FIG. 3 will be described. Upon transmitting a DRC index of 0×5, an AT is to receive a multi-user packet mapped to (128, 4, 256), (256, 4,256), (512, 4, 256), (1024, 4, 256), and (2048, 4, 128). This multi-user packet contains packet data of the multiple users, and is transmitted along with an address of an AT to receive each packet. Upon receiving the multi-user packet, the AT determines whether its own MAC ID is included within the packet, and processes its user packet only when its own MAC ID is included.

FIG. 4 illustrates a structure of a conventional multi-user packet used in the EVDO system.

Referring to FIG. 4, the multi-user packet is provided with a header, a payload 430 containing user data, a pad 440, and a trailer 450. The header includes a Packetlnfo field 400 for indicating an MAC ID corresponding to an address of a receiving AT, a Length field 410 for indicating a length of data to be transmitted to an associated AT, a Header Delimiter field 420 for indicating a boundary to separate a header and the remaining part, and so on.

In detail, the header of the multi-user packet contains information necessary to receive the multi-user packet in each AT. This information is provided with a Format field 401 for indicating information about a format of transmitted data, a MACIndex field 403 for indicating an ID of a receiving AT, and a Length field 410 for indicating a length of transmitted data (i.e., data transmitted in an MUP (hereinafter, referred to as a user packet)).

On the other hand, the Delimiter field 420 for separating the header and the payload contains “00000000” after the header containing N reception information elements for N receiving ATs. After the Delimiter field 420, the payload 430 contains user packets for the N ATs based on the order, data format, and length designated in the header information. After the payload 430, the pad 440 can be attached according to need. After the pad 440, the trailer 450 fixed to “00” is placed at the end, such that one multi-user packet is generated.

The multi-user packet is transmitted using a preamble allocated therefor. According to a transmission rate of the multi-user packet, multiple preambles are defined. For example, one preamble is used for a multi-user packet of (128, 4, 256), (256, 4, 256), (512, 4,256), and (1024, 4, 256) at a low transmission rate. Another preamble is used for a multi-user packet of (2048, 4, 128). Different preambles may be used for (3072, 2, 64), (4096,2,64), and (5120, 2, 64). Upon reporting a DRC value, an AT determines whether a preamble mapped to a multi-user packet compatible with the transmitted DRC value has been received. Upon receiving the preamble mapped to the multi-user packet compatible with the transmitted DRC value, the AT decodes the multi-user packet and determines whether its own address is present in a header. When an associated address is present, the AT reads an associated user packet of a length defined in the header from a payload, and then processes the read user packet.

As a higher data rate has recently been required in the mobile communication system, a multi-carrier EVDO system has been proposed to implement the higher data rate in the above-described 1× EVDO system. In the conventional EVDO system for transmitting and receiving data using one carrier, the multi-carrier EVDO system can implement a higher transmission rate by allocating multiple carriers to one AT. Because each of the multiple carriers can provide a maximum transmission rate in the conventional EVDO system, an AT performing communication using the multiple carriers can use a maximum data rate increased by the increased number of carriers in an ideal environment.

Because one AT receives one or more carriers in the multi-carrier system, the average number of ATs capable of receiving data on a carrier-by-carrier basis increases. Therefore, a need exists for a method capable of providing AT IDs mapped to an increased number of ATs on the carrier-by-carrier basis.

### SUMMARY OF THE INVENTION

Exemplary embodiments of the present invention address at least the above problems and/or disadvantages and provide at least the advantages described below. Accordingly, an exemplary aspect of the present invention is to provide an apparatus and method for providing an increased number of Access Terminal (AT) Identifiers (IDs) using a multi-user packet of more than a specific number of ATs with the support of an existing system and transmitting and receiving a forward packet using an increased number of AT IDs.

It is another exemplary object of the present invention to provide an apparatus and method for using one carrier to support more than a maximum number of users with the support of a conventional physical layer structure without changing the conventional physical layer structure in a mobile communication system for transmitting high rate data using multiple carriers.

In accordance with an exemplary aspect of the present invention, there is provided a method for receiving a packet in an Access Terminal (AT) of a mobile communication system for transmitting and receiving one multi-user packet configured by data to be transmitted from an Access Network Transceiver System (ANTS) to at least one AT for performing packet communication within an area of the ANTS, comprising receiving predetermined low information relative to an associated user packet through a multi-user packet received from the ANTS, analyzing the predetermined low information and determining whether an extension header is present, and checking a reception address of the user packet and a Medium Access Control (MAC) Identifier (ID) of the AT and processing the user packet.

In accordance with another exemplary aspect of the present invention, there is provided a method for generating and transmitting one packet with data to be transmitted to at least one Access Terminal (AT) in an Access Network Transceiver System (ANTS) of a mobile communication system comprising the ANTS for communicating with the at least one AT and the at least one AT for performing packet data communication within an area of the ANTS, comprising selecting a user packet of an associated AT for receiving data to be transmitted, generating predetermined low information relative to the user packet and an extension header, adding reception information of the associated AT to a Medium Access Control (MAC) header and adding the user packet to a payload, and generating and transmitting a packet of a predetermined number of multiple users with the user packet.

In accordance with another exemplary aspect of the present invention, there is provided an apparatus for receiving a packet in an Access Terminal (AT) of a mobile communication system for transmitting and receiving one multi-user packet configured by data to be transmitted from an Access Network Transceiver System (ANTS) to at least one AT for performing packet communication within an area of the ANTS, comprising a receiver for receiving a multi-user packet received from the ANTS and a data processor for receiving predetermined low information relative to an associated user packet through the multi-user packet, analyzing the predetermined low information and determining whether an extension header is present, checking a reception address of the user packet and a Medium Access Control (MAC) Identifier (ID) of the AT, and processing the user packet.

In accordance with another exemplary aspect of the present invention, there is provided an apparatus for generating and transmitting one packet with data to be transmitted to at least one Access Terminal (AT) in an Access Network Transceiver System (ANTS) of a mobile communication system comprising the ANTS for communicating with the at least one AT and the at least one AT for performing packet data communication within an area of the ANTS, comprising means for selecting a user packet of an associated AT for receiving data to be transmitted, generating predetermined low information relative to the user packet and an extension header, adding reception information of the associated AT to a Medium Access Control (MAC) header and adding the user packet to a payload, and generating and transmitting a packet of a predetermined number of multiple users with the user packet.

In accordance with yet another exemplary aspect of the present invention, there is provided a mobile communication system for generating and transmitting one packet with data to be transmitted to at least one Access Terminal (AT) in an Access Network Transceiver System (ANTS), the mobile communication system comprising the ANTS for communicating with the at least one AT and the at least one AT for performing packet data communication within an area of the ANTS, comprising an ANTS for selecting a user packet of an associated AT for receiving data to be transmitted, generating predetermined low information relative to the user packet and an extension header, adding reception information of the associated AT to a Medium Access Control (MAC) header, adding the user packet to a payload, and generating and transmitting a packet of a predetermined number of multiple users with the user packet and the at least one AT for receiving predetermined low information relative to an associated user packet through the multi-user packet received from the ANTS, analyzing the predetermined low information, determining whether the extension header is present, checking a reception address of the user packet and its own Medium MAC Identifier (ID), and processing the user packet.

### BRIEF DESCRIPTION OF THE DRAWINGS

The above and other objects and aspects of the present invention will be more clearly understood from the following detailed description taken in conjunction with the accompanying drawings, in which:

FIG. 1 illustrates a network structure of a conventional Evolution Data Only (EVDO) system;

FIG. 2 is a table illustrating a relation among a Data Rate Control (DRC) value reported by an Access Terminal (AT), a transmission rate, and a transmission format mapped thereto in an EVDO system;

FIG. 3 illustrates a definition of a multi-user packet compatible with a DRC value reported by an AT in the EVDO system;

FIG. 4 illustrates a structure of a conventional multi-user packet used in the EVDO system;

FIGS. 5A and 5B illustrate an example of a first structure of the multi-user packet in accordance with an exemplary embodiment of the present invention;

FIG. 6 illustrates an example of a second structure of the multi-user packet in accordance with an exemplary embodiment of the present invention;

FIG. 7 illustrates an example of a third structure of the multi-user packet in accordance with an exemplary embodiment of the present invention;

FIG. 8 is a flowchart illustrating an operation of an AT for receiving the multi-user packet according to the example of the first structure of FIG. 5A;

FIG. 9 is a flowchart illustrating an operation of an Access Network Transceiver System (ANTS) for generating the multi-user packet according to the example of the first structure of FIG. 5A;

FIG. 10 is a flowchart illustrating an operation of an AT for receiving the multi-user packet according to the examples of the second and third structures of FIGS. 6 and 7;

FIG. 11 is a flowchart illustrating an operation of an ANTS for generating the multi-user packet according to the examples of the second and third structures of FIGS. 6 and 7; and

FIG. 12 is a block diagram illustrating a device of the ANTS for transmitting the multi-user packet and a device of the AT for receiving the multi-user packet in accordance with an exemplary embodiment of the present invention.

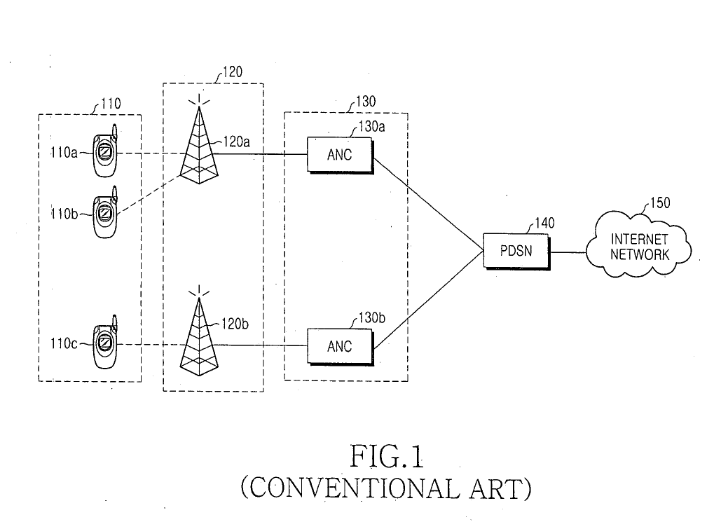

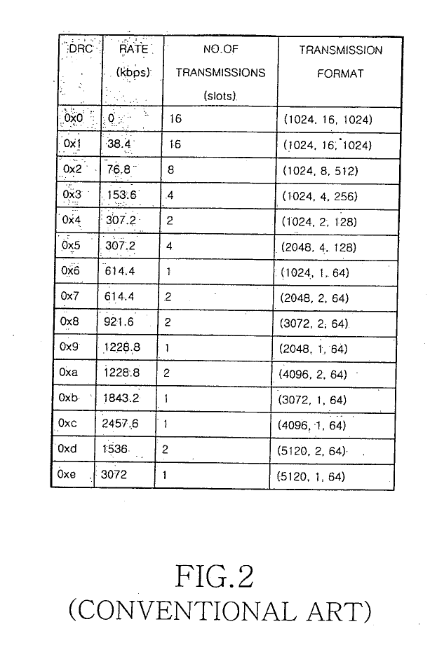

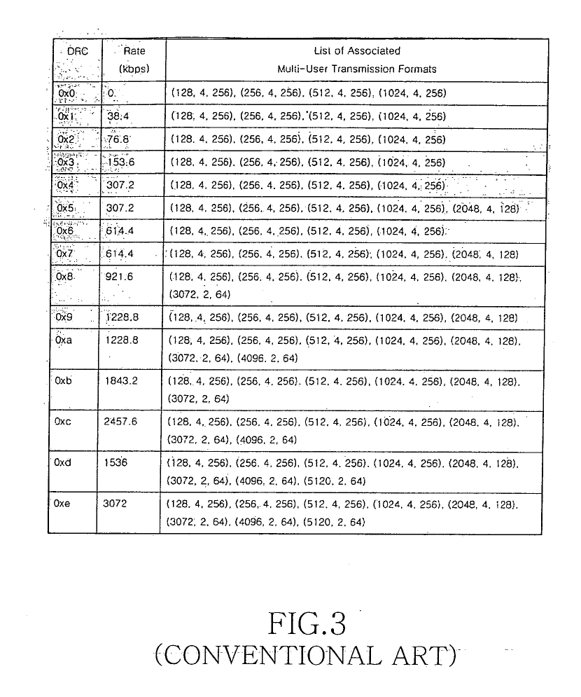

### DETAILED DESCRIPTION OF EXEMPLARY EMBODIMENTS

The operation principles of exemplary embodiments of the present invention will be described in detail herein below with reference to the accompanying drawings. In the drawings, the same or similar elements are denoted by the same reference numerals even though they are depicted in different drawings. In the following description, detailed descriptions of functions and configurations incorporated herein that are well known to those skilled in the art are omitted for clarity and conciseness. It is to be understood that the phraseology and terminology employed herein are for the purpose of description and should not be regarded as limiting the present invention.

A change in a physical transmission structure of an existing Evolution Data Only (EVDO) system is limited in the first step of a multi-carrier system such that the conventionally commercialized EVDO system can be easily switched to the multi-carrier system. To support a number of users increased on a carrier-by-carrier basis under this limitation, the present invention proposes a method for supporting more than a specific number of Access Terminals (ATs) with the support of the existing system by correcting a header of a multi-user packet, and an apparatus and method for transmitting and receiving a forward packet with the corrected header.

To support an increased number of ATs while maintaining the structure of the existing system, the present invention uses an n-bit extension Medium Access Control (MAC) Identifier (ID) in addition to a 7-bit MAC ID serving as a conventionally used AT ID. Because a physical change is limited even when a size of the MAC ID increases, a preamble cannot be newly defined. Because of this limitation, a single user packet cannot be transmitted to an AT using the extension MAC ID. Therefore, the present invention proposes an apparatus and method for correcting a structure of a multi-user packet in place of a single user packet and transmitting and receiving a user packet for an AT assigned an extension MAC ID. For this, the present invention proposes a multi-user packet structure including an extension header and additional information in addition to reception information included in a header of an existing multi-user packet.

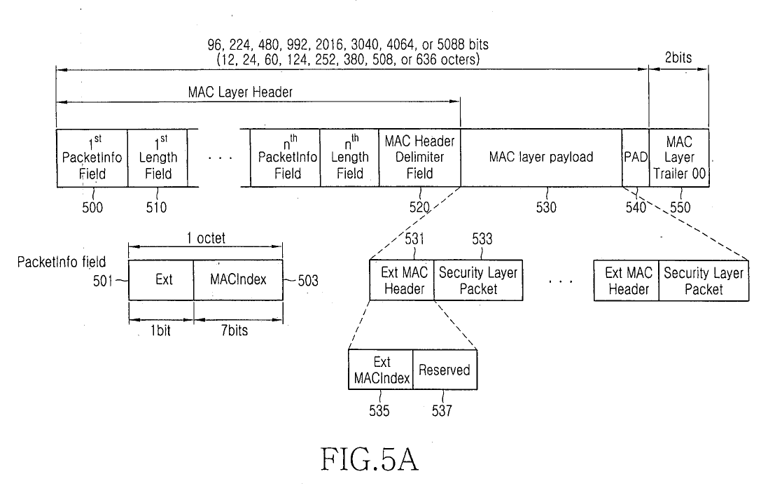

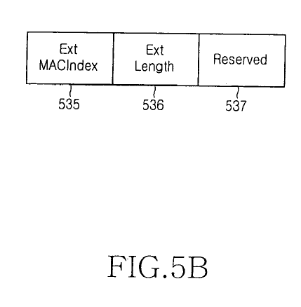

FIGS. 5A and 5B illustrate an example of a first structure of the multi-user packet in accordance with an exemplary embodiment of the present invention.

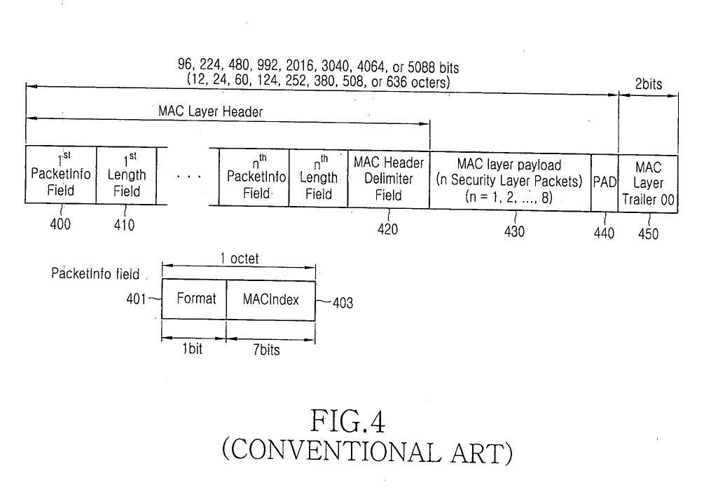

Referring to FIG. 5A, a header size of the multi-user packet is maintained without a change such that ATs using the existing multi-user packet structure are not affected. That is, fields 500, 510, 520, 530, 540, and 550 are the same as the corresponding fields of the packet structure of FIG. 4.

Only, the Format field 401 of FIG. 4 used for format information of data to be transmitted is changed and is used as an extension indicator 501 for indicating the presence of an extension header. When the extension indicator 501 of the header for the i^{th} security layer packet 533 is set to “1”, the AT extends the first several bits of a user packet of the i^{th} AT included in a payload and detects a new header. This new header is referred to as the extension header 531.

Upon receiving the extension header 531, the AT generates a MAC ID of at least 7 bits by concatenating additional MAC ID information included in the extension header 531 with the MAC ID of the conventional header. According to a concatenation scheme and the like, the additional MAC ID information of the extension header 531 may be attached before the MAC ID of the conventional header. Upon receiving the MAC ID of at least 7 bits, the AT regards and processes associated data as its own data if the received MAC ID is equal to a MAC ID allocated to the AT.

When the extension indicator is “1”, the extension header 531 may include an ExtLength field 536, additional information about a receiving AT or a Reserved field 537, and the like as well as the above-described extension MAC ID information.

FIG. 5B illustrates an example of an extension header including the above-described ExtLength field 536. The ExtLength field 536 can be included in the extension header when an existing length field of a multi-user packet is insufficient to indicate a size of a total user packet. When the ExtLength field 536 is used in the extension header, it is concatenated with the existing length field according to the concatenation scheme and the like. Moreover, the ExtLength field 536 can indicate a size of a longer packet using an increased number of bits.

When the ExtLength field 536 is used, length information of a specific user packet included in the extension header cannot be detected using only the existing length field. When an AT cannot interpret the extension header, it cannot know a length of a specific packet and cannot exactly detect a boundary of other packets subsequent to the specific packet. Thus, the ExtLength field 536 can be used in a multi-user packet including only one user packet or can be used in the last user packet of a multi-user packet.

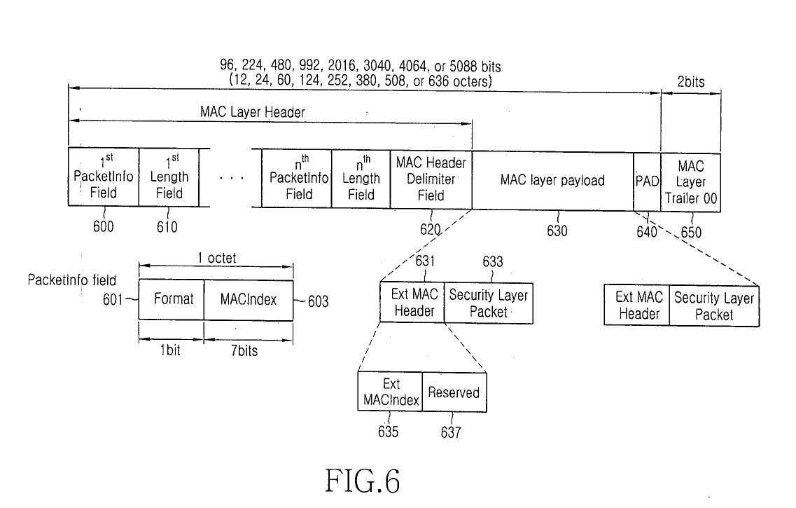

FIG. 6 illustrates an example of a second structure of the multi-user packet in accordance with an exemplary embodiment of the present invention.

Referring to FIG. 6, the second structure of the multi-user packet uses a header structure of the conventional multi-user packet of FIG. 4 without a change. That is, fields 600, 610, 620, 630, 640, and 650 are the same as the corresponding fields of the packet structure of FIG. 4, and fields 631, 633, 635, and 637 are the same as those of the packet structure of FIG. 5A.

If a MAC index of the header is “1111111”, it means that an extension header is included. In this case, an extension MAC index included in the extension header is to be one complete MAC ID, which is different from the example of FIGS. 5A and 5B. In the example of FIGS. 5A and 5B, one complete MAC ID is configured by concatenating the MAC index of the header with the extension MAC index. However, in the example of FIG. 6, the extension MAC index includes all MAC ID information, because the MAC index of the header only indicates that the extension header is included when its value is “1111111”.

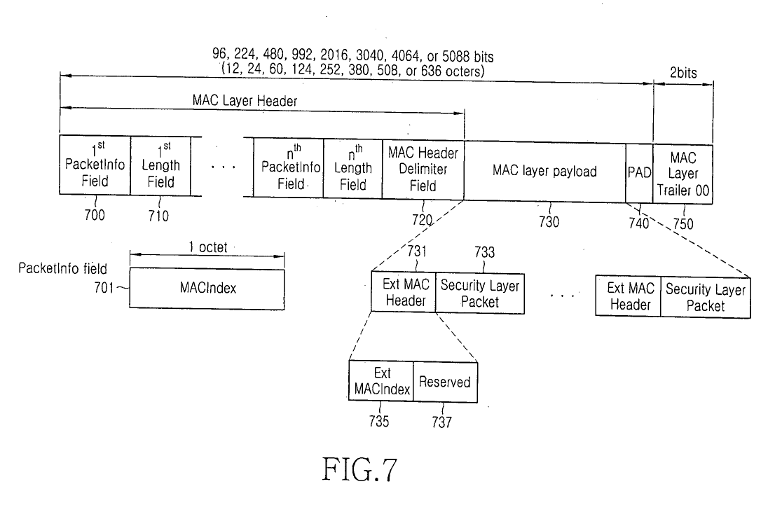

FIG. 7 illustrates an example of a third structure of the multi-user packet in accordance with an exemplary embodiment of the present invention.

Referring to FIG. 7, the third structure of the multi-user packet uses a header structure of the conventional multi-user packet of FIG. 4 without a change. That is, fields 700, 710, 720, 730, 740, and 750 are the same as the corresponding fields of the packet structure of FIG. 4, and fields 731, 733, 735, and 737 are the same as those of the packet structure of FIG. 5A. In the example of the third structure of the multi-user packet, the conventional format bit is removed and an 8-bit MAC index is included in a header of the multi-user packet. If a value of the 8-bit MAC index is “11111111” in the example of the third structure of the multi-user packet, it means that an extension header is included. A structure of the extension header and an operation of a receiving AT are the same as in the example of FIG. 6.

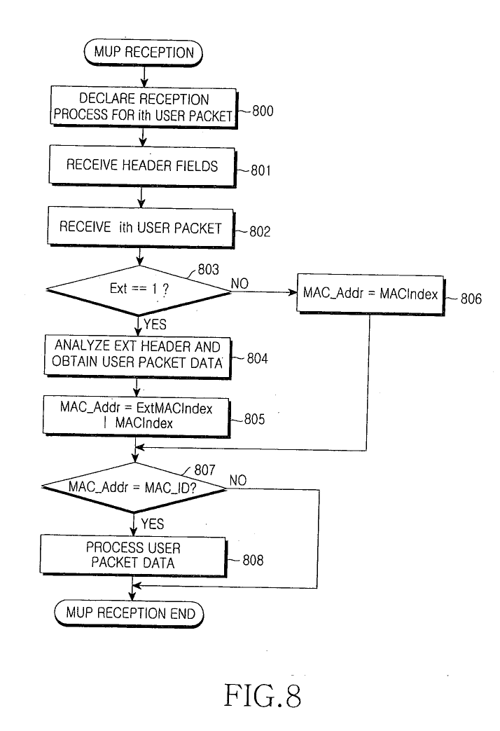

FIG. 8 is a flowchart illustrating an operation of an AT for receiving the multi-user packet according to the example of the first structure of FIG. 5A.

The AT declares a reception process for reception information (relative to the i^{th} user packet) within the received multi-user packet in step 800. Upon receiving the multi-user packet, the AT divides and receives reception information about each user packet within the multi-user packet, in other words Ext, MACIndex, and Length fields, in step 801. The AT retrieves and reads a user packet mapped to the reception information from a payload in step 802. When a value of the received Ext field is “1” in step 803, the AT determines that an extension header is present.

In step 804, the AT separates the extension header before a user packet, obtains an ExtLength field and an ExtMACIndex field corresponding to extension MAC ID information included and transmitted in the extension header, and obtains an actual user packet corresponding to data except the extension header. In step 805, the AT concatenates the received MACIndex field with the ExtMACIndex field to generate a reception address of an associated user packet. Herein, an operator “|” indicates the concatenation. Subsequently, when the reception address (MAC_Addr) of the associated user packet is equal to an MAC ID of the AT in step 807, the AT processes the associated user packet in step 808.

On the other hand, when the value of the Ext field is “0”, not “1”, in step 803, the AT determines that the extension header is absent. In step 806, the AT determines that the received MACIndex is the reception address of the associated user packet. Subsequently, when the reception address of the associated user packet is equal to the MAC ID of the AT in step 807, the AT processes the associated user packet in step 808.

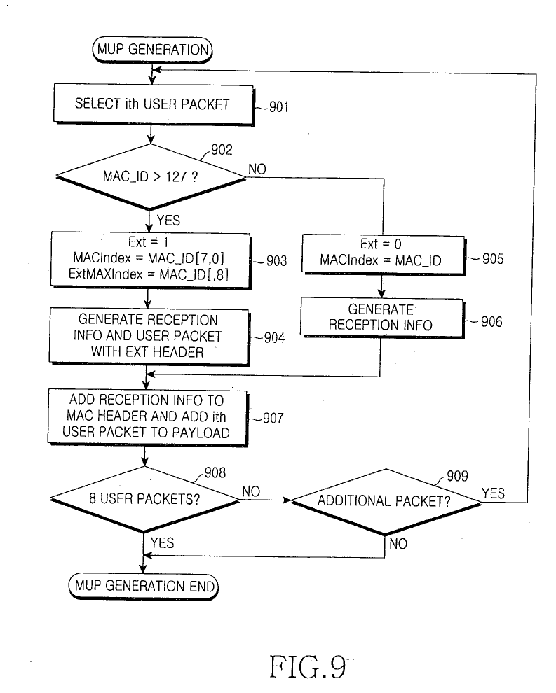

FIG. 9 is a flowchart illustrating an operation of an ANTS for generating the multi-user packet according to the example of the first structure of FIG. 5A.

The ANTS selects a user packet of a specific AT as the i^{th} user packet to be included in the multi-user packet in step 901. When the associated AT uses a MAC ID of more than 127 (i.e., a maximum MAC ID capable of being expressed by 7 bits) in step 902, the ANTS determines that an extension header is necessary to transmit associated data. Upon determining that the extension header is necessary, the ANTS sets an Ext field corresponding to an extension indicator to “1”, sets a MACIndex field to be included in a header to 7 less significant bits of a MAC ID of the AT, sets an ExtMACIndex field to be included in the extension header to the remaining more significant bits of the MAC ID of the AT, and sets a length field to a total length value of the user packet and the extension header in step 903. Subsequently, the ANTS generates reception information including the Ext, MACIndex, and Length fields and the like, and generates a new user packet by adding the extension header before the user packet in step 904. The ANTS adds the generated reception information to the header of the multi-user packet, adds the new user packet to the payload, and generates a multi-user packet including the i^{th} user packet in step 907.

On the other hand, when the MAC ID of the associated AT is less than or equal to “127” instep 902, the ANTS determines that the extension header is unnecessary. In step 905, the ANTS sets the Ext field to “0” and sets the MACIndex field to the MAC ID of the associated AT. In step 906, the ANTS generates the reception information including the Ext, MACIndex, and Length fields. Subsequently, the ANTS adds the generated reception information to the header of the multi-user packet, and adds the user packet of the associated AT to the payload in step 907.

When 8 user packets corresponding to a maximum number of user packets capable of being transmitted in the multi-user packet are generated in step 908, the ANTS ends the MUP generation process and transmits the associated packet. However, when the multi-user packet includes less than 8 user packets in step 908, the ANTS determines whether a new user packet can be added in step 909. Upon determining that the new user packet can be added as a determination result, the ANTS repeats steps 901 to 907. However, if the new user packet cannot be added, the ANTS ends the MUP generation process and transmits the associated packet.

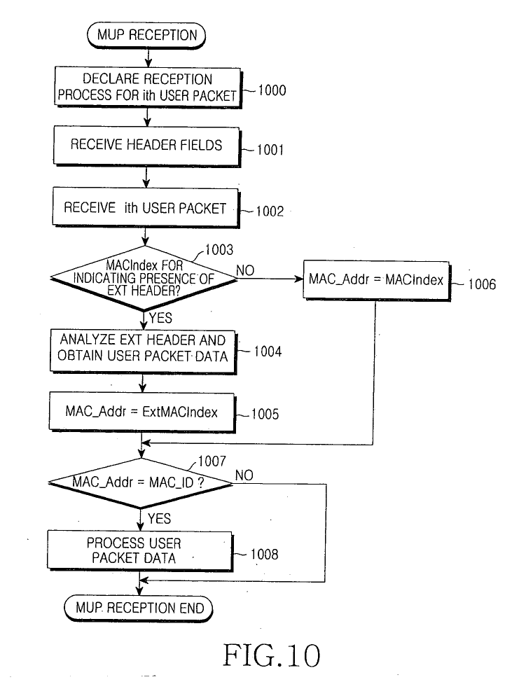

FIG. 10 is a flowchart illustrating an operation of an AT for receiving the multi-user packet according to the examples of the second and third structures of FIGS. 6 and 7.

The AT declares a reception process for reception information (relative to the i^{th} user packet) within the received multi-user packet in step 1000. Upon receiving the multi-user packet, the AT divides and receives reception information about each user packet within the multi-user packet, in other words MACIndex and Length fields, in step 1001. The AT retrieves and reads a user packet mapped to the reception information from a payload in step 1002.

When a value of the received MACIndex field is a specific value indicating the presence of an extension header, the AT determines that the extension header is present in step 1003. Upon determining that the extension header is present, the AT separates an extension header before a user packet, obtains information about an ExtLength field and an ExtMACIndex field corresponding to extension MAC ID information included and transmitted in the extension header, and obtains an actual user packet corresponding to data except the extension header in step 1004. In step 1005, the AT set the received ExtMACIndex field to an actual reception address of an associated user packet. Subsequently, when the reception address (MAC_Addr) of the associated user packet is equal to an MAC ID of the AT in step 1007, the AT processes the associated user packet in step 1008.

On the other hand, when the value of the received MACIndex field is not a specific value indicating the presence of the extension header in step 1003, the AT determines that the extension header is absent. In step 1006, AT determines that the received MACIndex field is the reception address of the associated user packet. Subsequently, when the reception address of the associated user packet is equal to the MAC ID of the AT in step 1007, the AT processes the associated user packet in step 1008.

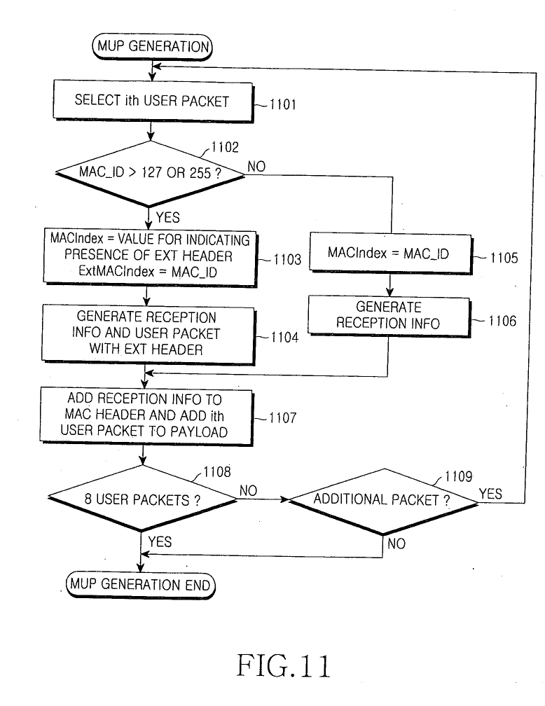

FIG. 11 is a flowchart illustrating an operation of an ANTS for generating the multi-user packet according to the examples of the second and third structures of FIGS. 6 and 7.

Referring to FIG. 11, the ANTS selects a user packet of a specific AT as the i^{th} user packet to be included in the multi-user packet in step 1101. When the associated AT uses a MAC ID of more than 127 (i.e., a maximum MAC ID capable of being expressed by 7 bits in the example of the second structure) or 255 (i.e., a maximum MAC ID capable of being expressed by 8 bits in the example of the third structure) in step 1102, the ANTS determines that an extension header is necessary to transmit associated data. Upon determining that the extension header is necessary, the ANTS sets a MACIndex field to be included in a header to a specific value indicating the presence of an extension header (for example, a value of “1111111”in the MACIndex field of 7 bits, or a value of “11111111” in the MACIndex field of 8 bits), and sets a length field to a total length value of the user packet and the extension header in step 1103. Moreover, the ANTS sets an ExtMACIndex field to be included in the extension header to an actual MAC ID of the AT. Subsequently, the ANTS generates reception information including the MACIndex and Length fields, and generates a new user packet by adding the extension header before the user packet in step 1104. The ANTS adds the generated reception information to the header of the multi-user packet, adds the new user packet to the payload, and generates a multi-user packet including the i^{th} user packet in step 1107.

On the other hand, when the MAC ID of the associated AT is less than or equal to “127” in step 1102, the ANTS determines that the extension header is unnecessary. In step 1105, the ANTS sets the MACIndex field to the MAC ID of the associated AT. In step 1106, the ANTS generates the reception information including the MACIndex and Length fields. Subsequently, the ANTS adds the generated reception information to the header of the multi-user packet, and adds the user packet of the associated AT to the payload in step 1107.

When 8 user packets corresponding to a maximum number of user packets capable of being transmitted in the multi-user packet are generated in step 1108, the ANTS ends the MUP generation process and transmits the associated packet. However, when the multi-user packet includes less than 8 user packets in step 1108, the ANTS determines whether a new user packet can be added in step 1109. Upon determining that the new user packet can be added as a determination result, the ANTS repeats steps 1101 to 1107. However, if the new user packet cannot be added, the ANTS ends the MUP generation process and transmits the associated packet.

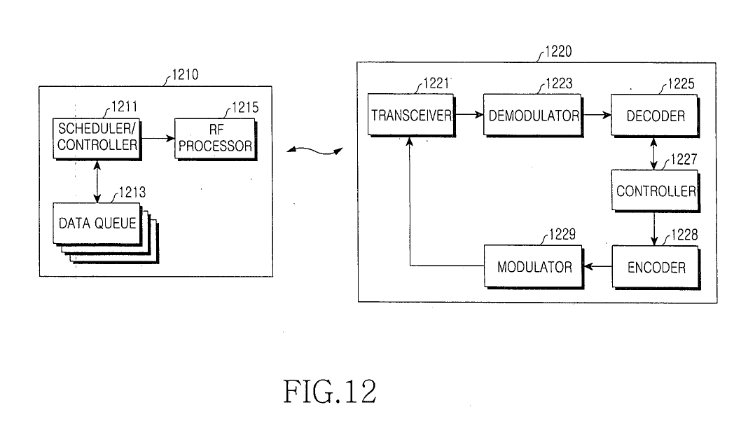

FIG. 12 is a block diagram illustrating a device of the ANTS for transmitting the multi-user packet and a device of the AT for receiving the multi-user packet in accordance with an exemplary embodiment of the present invention.

Referring to FIG. 12, the ANTS device 1210 for generating the multi-user packet includes a scheduler/controller 1211, a radio frequency processor 1215, and a data queue1213. The AT device 1220 for receiving the multi-user packet includes a transceiver 1221, a demodulator 1223, a decoder 1225, a controller 1227, an encoder 1228, and a modulator 1229.

In the ANTS device 1210, the data queue 1213 stores data received from a higher node on an AT-by-AT or service-by-service basis. The scheduler/controller 1211 selects/controls data of a specific user or queue while considering channel situations, service characteristics, fairness, and the like. The radio frequency processor 1215 transmits a signal of the selected/controlled data to the AT device 1220.

In the AT device 1220, the demodulator 1223 demodulates a signal received by the transceiver 1221. The decoder 1225 decodes the demodulated signal. The controller 1227 performs a determination process. When data to be transmitted is generated from the AT device 1220, the encoder 1228 encodes associated data. The modulator 1229 modulates the encoded data. The transceiver 1221 transmits a signal of the modulated data to the ANTS device 1210.

As described above, the exemplary embodiments of the present invention have the following effects.

The exemplary embodiments of the present invention provide a method and apparatus for supporting more than a specific number of ATs with the support of an existing system by correcting a header of a multi-user packet.

Moreover, the exemplary embodiments of the present invention can support a number of users increased on a carrier-by-carrier basis without changing a physical transmission structure of an existing EVDO system.

Although the exemplary embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A method for receiving a packet in an Access Terminal (AT) of a mobile communication system, the method comprising:
receiving information relative to an associated user packet through a multi-user packet received from an Access Network Transceiver System (ANTS);
analyzing the received information and determining whether the received information comprises an extension header; and
checking a reception address of the associated user packet and a Medium Access Control (MAC) Identifier (ID) of an AT and processing the associated user packet.

2. The method of claim 1, wherein the information comprises at least one of an extension indicator, a MAC index, and a length.

3. The method of claim 1, wherein the analyzing of the received information comprises determining whether an extension indicator is “1”.

4. The method of claim 1, wherein the analyzing of the received information comprises determining whether a MAC index is a value for indicating the presence of the extension header.

5. The method of claim 1, wherein the extension header comprises at least one of an extension MAC index field, an extension length field, and a reserved field.

6. The method of claim 1, further comprising separating at least one of an extension MAC index field and an extension length field from the user packet if the extension header is present as a determination result.

7. The method of claim 1, further comprising configuring the reception address of the associated user packet by concatenating an extension MAC index with a MAC index.

8. The method of claim 1, further comprising configuring the reception address of the user packet by an extension MAC index.

9. A method for generating and transmitting at least one packet with data to be transmitted to at least one Access Terminal (AT) in an Access Network Transceiver System (ANTS) of a mobile communication system, the method comprising the steps of:
selecting a user packet of an associated AT for receiving data to be transmitted;
generating information relative to the user packet and an extension header;
adding reception information of the associated AT to a Medium Access Control (MAC) header and adding the user packet to a payload; and
generating and transmitting a packet comprising a number of multiple users with the user packet.

10. The method of claim 9, wherein the information comprises at least one of an extension indicator, a MAC index, and a length.

11. The method of claim 9, wherein the generating of the extension header comprises determining whether a MAC Identifier (ID) is greater than a value.

12. The method of claim 11; further comprising, if the MAC ID is greater than the value as a determination result:
setting an extension indicator to “1”;
setting a MAC index to 7 less significant bits of the MAC ID; and
setting an extension MAC index to the remaining more significant bits of the MAC ID.

13. The method of claim 11, further comprising, if the MAC ID is less than or equal to the value as a determination result:
setting an extension indicator to “0”; and
setting a MAC index to the MAC ID.

14. The method of claim 11, further comprising, if the MAC ID is more than the preset value as a determination result:
setting a MAC index to a specific value for indicating presence of the extension header; and
setting an extension MAC index to the MAC ID.

15. The method of claim 11, further comprising setting a MAC index to the MAC ID if the MAC ID is less than or equal to the preset value as a determination result.

16. The method of claim 9, wherein the generating the multi-user packet comprises:
determining whether an additional user packet is present; and
returning to the step of selecting the user packet.

17. An apparatus for receiving a packet in an Access Terminal (AT) of a mobile communication system, the apparatus comprising:
a receiver for receiving a multi-user packet from an Access Network Transceiver System (ANTS); and
a data processor for receiving information relative to an associated user packet through the multi-user packet, analyzing the information and determining whether an extension header is present, checking a reception address of the user packet and a Medium Access Control (MAC) Identifier (ID) of the AT, and processing the user packet.

18. The apparatus of claim 17, wherein the information comprises at least one of an extension indicator, a MAC index, and a length.

19. The apparatus of claim 17, wherein the analyzing of the information comprises determining whether an extension indicator is “1”.

20. The apparatus of claim 17, wherein the analyzing the information comprises determining whether a MAC index is a value indicating the presence of the extension header.

21. The apparatus of claim 17, wherein the extension header comprises at least one of an extension MAC index field, an extension length field, and a reserved field.

22. The apparatus of claim 17, wherein if the extension header is present as a determination result, an extension MAC index field and an extension length field are separated from the user packet.

23. The apparatus of claim 17, wherein the reception address of the user packet is configured by concatenating an extension MAC index with a MAC index.

24. The apparatus of claim 17, wherein the reception address of the user packet is configured by an extension MAC index.

25. An apparatus for generating and transmitting one packet with data to be transmitted to at least one Access Terminal (AT) in an Access Network Transceiver System (ANTS) of a mobile communication system, the apparatus comprising:
means for selecting a user packet of an associated AT for receiving data to be transmitted;
means for generating predetermined low information relative to the user packet and an extension header;
means for adding reception information of the associated AT to a Medium Access Control (MAC) header and adding the user packet to a payload; and
means for generating and transmitting a packet of a predetermined number of multiple users with the user packet.

26. The apparatus of claim 25, wherein the predetermined low information comprises at least one of an extension indicator, a MAC index, and a length.

27. The apparatus of claim 25, wherein when the extension header is generated, a determination is made as to whether a MAC Identifier (ID) is greater than a value.

28. The apparatus of claim 25, wherein if the MAC ID is greater than the value as a determination result, an extension indicator is set to “1”, a MAC index is set to 7 less significant bits of the MAC ID and an extension MAC index is set to the remaining more significant bits of the MAC ID.

29. The apparatus of claim 25, wherein if the MAC ID is less than or equal to the value as a determination result, an extension indicator is set to “0” and a MAC index is set to the MAC ID.

30. The apparatus of claim 25, wherein if the MAC ID is greater than the value as a determination result, a MAC index is set to a specific value for indicating presence of the extension header and an extension MAC index is set to the MAC ID.

31. The apparatus of claim 25, wherein if the MAC ID is less than or equal to the value as a determination result, a MAC index is set to the MAC ID.

32. The apparatus of claim 26, wherein when the multi-user packet is generated, a determination is made as to whether an additional user packet is present and the additional user packet is selected according to a determination result.

33. A mobile communication system for generating and transmitting at least one packet with data to be transmitted to at least one Access Terminal (AT) in an Access Network Transceiver System (ANTS), the mobile communication system comprising:
an ANTS for selecting a user packet of an associated AT for receiving data to be transmitted, generating information relative to the user packet and an extension header, adding reception information of the associated AT to a Medium Access Control (MAC) header, adding the user packet to a payload, and generating and transmitting a packet of a number of multiple users with the user packet; and
at least one AT for receiving the information relative to an associated user packet through the multi-user packet received from the ANTS, analyzing the information, determining whether the extension header is present, checking a reception address of the user packet and a Medium MAC Identifier (ID), and processing the user packet.

34. The method of claim 2, wherein the analyzing of the received information comprises determining whether an extension indicator is “1”.

35. The method of claim 2, wherein the analyzing of the received information comprises determining whether a MAC index comprises a value for indicating the presence of the extension header.

36. The method of claim 6, further comprising configuring the reception address of the associated user packet by concatenating an extension MAC index with a MAC index.

37. The method of claim 6, further comprising configuring the reception address of the user packet by an extension MAC index.

38. The apparatus of claim 18, wherein the analyzing of the information comprises determining whether an extension indicator is “1”.

39. The apparatus of claim 18, wherein the analyzing of the information comprises determining whether a MAC index is a value indicating the presence of the extension header.

40. The apparatus of claim 22, wherein the reception address of the user packet is configured by concatenating an extension MAC index with a MAC index.

41. The apparatus of claim 22, wherein the reception address of the user packet is configured by an extension MAC index.

42. The method of claim 1, wherein the mobile communication system transmits and receives one multi-user packet configured by data to be transmitted from an Access Network Transceiver System (ANTS) to at least one AT for performing packet communication within an area of the ANTS.

43. The method of claim 9, wherein the mobile communication system comprises the ANTS for communicating with the at least one AT and the at least one AT for performing packet data communication within an area of the ANTS

44. The apparatus of claim 17, wherein the mobile communication system transmits and receives one multi-user packet configured by data to be transmitted from an Access Network Transceiver System (ANTS) to at least one AT for performing packet communication within an area of the ANTS.

45. The apparatus of claim 25, wherein the apparatus comprises the ANTS for communicating with the at least one AT and the at least one AT for performing packet data communication within an area of the ANTS.
